(19) United States
(12) Patent Application Publication
(10) Pub. No.: US 2015/0294230 A1
(43) Pub. Date: Oct. 15, 2015

(54) METHODS AND SYSTEMS FOR MODELING CLOUD USER BEHAVIOR

(71) Applicant: Xerox Corporation, Norwalk, CT (US)

(72) Inventors: Tridib Mukherjee, Bangalore (IN); Sakyajit Bhattacharya, Bangalore (IN); Koustuv Dasgupta, Bangalore (IN)

(73) Assignee: Xerox Corporation, Norwalk, CT (US)

(21) Appl. No.: 14/250,407

(22) Filed: Apr. 11, 2014

(51) Int. Cl. G06N 7/00; G06N 99/00; G06F 17/30; H04L 29/08

(52) U.S. Cl. CPC G06N 7/005; H04L 67/10; G06N 99/005; G06F 17/30598

(57) ABSTRACT

Some embodiments are directed to a system for identifying clusters from a plurality of users using cloud services. A behavior collection module is configured to obtain user preferences for the plurality of users, and an EM module to configured estimate at least one parameter of a distance-based model by the Expectation-Maximization (EM) algorithm for various values of G (number of clusters). A selection module is configured to compute Bayesian Information Criteria (BIC) with the at least one estimated parameter obtained from the EM module for various values of G, compare BICs obtained for various values of G, select the model with the highest BIC as the best model (best model including the plurality of clusters) and use estimated latent variables of the best model to build a classifier. A characterization module is configured to classify each user into a cluster of the best model using the classifier, and to determine ranking preference of each cluster.

### TECHNICAL FIELD

The presently disclosed embodiments relate to cloud services, and more particularly to methods and systems for modeling cloud user behavior.

### BACKGROUND

Cloud computing has emerged as one of the best methods for companies to revamp and enhance their IT infrastructures. Accordingly, there has been a proliferation of cloud-based service providers in recent years. However, a particular service offering from a particular provider may have a different level of acceptability to different user (or customer) groups depending on the users' preferences. The related art fails to provide a reliable technique to understand different cloud user groups and their behavior, in terms of acceptability of the providers offerings based on users' preferences. However, cloud-based service providers need to understand the different user groups and their behavior, so that they can then target offerings in different user groups according to users' preferences.

### SUMMARY

The cloud service offerings from these providers are not standardized. Due to this lack of standardization, similar offerings from different providers have different performance and cost implications, and customers are unable to compare the service offerings properly. Currently, customers are responsible for engaging in consultations with cloud service providers to identify an acceptable offering. With the increased focus towards standardization of computing clouds, it is important to understand which cloud offering is better fit for which user group, and accordingly create standards for the different user groups.

However, the problem of modeling user behavior and finding different user groups based on user preferences may be difficult based on a heterogeneous set of users, often spanned across scale (e.g., enterprise vs. small scale customers), economy (e.g., emerging vs. developed markets), geography, and time (e.g., for office-use in day time vs. personal use at nights). For example, in an emerging economy, or with regard to small and medium businesses (SMBs), the users may be less performance-savvy and more cost-concerned, whereas in a developed economy or with regard to large enterprises, the users may have a higher preference on the performance. This issue is exacerbated since the user groups, and the commonalities and differences of their behaviors, are typically unknown and need to be dynamically learned online from the user preferences. The preferences from a user can further change over time (e.g., a performance-savvy customer becoming cost conscious after a month or a year, etc.).

Related art methods of modeling user behaviors are based on a prior knowledge of the different user groups and the behaviors within each group. These methods involve segregation of user behavior into these known groups. However, cloud user groups and their behavior patterns are not known beforehand. Therefore, the related art methods are inapplicable for identification of cloud user groups. It may therefore be beneficial to systematically model the cloud users' behavior in terms of their preferences without any prior knowledge (or with only limited knowledge) of the clusters, then classify the users into different clusters and also predict behavior of new users.

Thus, some embodiments take into account preference data from different cloud users, including ranking of different preference parameters related to cloud service offerings. The user groups can be determined based on fitting mixture models on the preference observations. In some embodiments, a preference is constituted by anything that can characterize high-level requirements, such as demands on performance, cost, security, availability, etc.

In one aspect, the present disclosure provides a method for identifying a plurality of clusters from a plurality of users using at least one cloud service. The method includes obtaining user preferences for the plurality of users, and then estimating at least one parameter of a distance-based model by the Expectation-Maximization (EM) algorithm for a specific number of clusters (G) and computing Bayesian Information Criteria (BIC) with the at least one estimated parameter for the specific number of clusters (G). The method includes repeating the estimating and computing steps using a different value of G. Thereafter, the method includes comparing BICs obtained for various values of G and selecting the model with highest BIC as the best model, wherein the best model includes the plurality of clusters. The method also includes using estimated latent variables of the best model to build a classifier, and classifying each user into a cluster of the best model using the classifier.

In another aspect, the present disclosure provides a method for identifying a plurality of clusters from a plurality of users using at least one cloud service. The method includes obtaining user preferences for the plurality of users, and then estimating at least one parameter of a distance-based model by the EM algorithm for a specific number of clusters (G) and computing BIC with the at least one estimated parameter for the specific number of clusters (G). The method includes repeating the estimating and computing steps using a different value of G. Thereafter, the method includes comparing BICs obtained for various values of G and selecting the model with highest BIC as the best model, wherein the best model includes the plurality of clusters. Next, the method includes using estimated latent variables of the best model to build a classifier, classifying each user into a cluster of the best model using the classifier and determining ranking preference of each cluster in the best model. Further, the method includes obtaining user preferences of a new user, predicting the cluster of the new user using the classifier and characterizing the new user based on the predicted cluster. The method also includes repeating the method steps periodically based on updated user preferences.

In another aspect, the present disclosure provides an apparatus for identifying clusters from a plurality of users using cloud services. The apparatus includes a memory and a processor coupled to the memory. The processor is configured to execute the steps of obtaining user preferences for the plurality of users, estimating at least one parameter of a distance-based model by the EM algorithm for a specific number of clusters (G) and computing BIC with the at least one estimated parameter for the specific number of clusters (G). Next, the processor is configured to repeat the estimating and computing steps using a different value of G compare BICs obtained for various values of G, select the model with highest BIC as the best model use estimated latent variables of the best model to build a classifier. The processor is also configured to classify each user into a cluster of the best model using the classifier.

In a further aspect, the present disclosure provides a system for identifying clusters from a plurality of users using cloud services. The system includes a behavior collection module configured to obtain user preferences for the plurality of users. The system further includes an EM module to configured estimate at least one parameter of a distance-based model by the EM algorithm for various values of G (number of clusters). The system includes a selection module configured to compute BIC with the at least one estimated parameter obtained from the EM module for various G, compare BICs obtained for various values of G, select the model with highest BIC as the best model, wherein the best model comprising the plurality of clusters; and use estimated latent variables of the best model to build a classifier. The system also includes a characterization module configured to classify each user into a cluster of the best model using the classifier and determine ranking preference of each cluster.

In a yet further aspect, the present disclosure provides a computer readable carrier including processing instructions adapted to cause a processor to execute the method for identifying a plurality of clusters from a plurality of users using at least one cloud services. The method includes obtaining user preferences for the plurality of users. The method includes estimating at least one parameter of a distance-based model by the EM algorithm for a specific number of clusters (G) and computing BIC with the at least one estimated parameter for the specific number of clusters (G). The method includes repeating the estimating and computing steps using a different value of G. Thereafter, the method includes comparing BICs obtained for various values of G and selecting the model with highest BIC as the best model, wherein the best model includes the plurality of clusters. The method also includes using estimated latent variables of the best model to build a classifier and classifying each user into a cluster of the best model using the classifier.

In another aspect, the present disclosure provides a computer readable carrier that includes processing instructions adapted to cause a processor to execute the method for identifying a plurality of clusters from a plurality of users using at least one cloud services. The method includes obtaining user preferences for the plurality of users. The method includes estimating at least one parameter of a distance-based model by the EM algorithm for a specific number of clusters (G) and computing BIC with the at least one estimated parameter for the specific number of clusters (G). The method includes repeating the estimating and computing steps using a different value of G. Thereafter, the method includes comparing BICs obtained for various values of G and selecting the model with highest BIC as the best model, wherein the best model includes the plurality of clusters. Next, the method includes using estimated latent variables of the best model to build a classifier, classifying each user into a cluster of the best model using the classifier and determining ranking preference of each cluster in the best model. Further, the method includes obtaining user preferences of a new user, predicting the cluster of the new user using the classifier and characterizing the new user based on the predicted cluster. The method also includes repeating the method steps periodically based on updated user preferences.

In a further aspect, the disclosure provides a method for identifying a plurality of clusters from a plurality of users using at least one cloud services. Each cluster includes at least one user from the plurality of users. The method includes obtaining user preferences for the plurality of users. Next, the method includes estimating at least one parameter for each distance-based model in a plurality of distance-based models, wherein each distance-based model includes a different number of clusters (G). Thereafter, the method selects a best model from the plurality of distance-based models based on estimated value of the at least one parameter, and the method classifies each user into a cluster of the best model.

In a yet further aspect, the disclosure provides a system for identifying a plurality of clusters from a plurality of users using at least one cloud services. Each cluster includes at least one user from the plurality of users. The system includes a behavior collection module configured to obtain user preferences for the plurality of users. The system further includes an estimating module configured to estimate at least one parameter for each distance-based model in a plurality of distance-based models, wherein each distance-based model includes a different number of clusters (G). The system also includes a selection module configured to select a best model from the plurality of distance-based models based on estimated value of the at least one parameter. The system further includes a characterization module configured to classify each user into a cluster of the best model based on the best model and determine ranking preference of each cluster.

### BRIEF DESCRIPTION OF THE DRAWINGS

FIG. 1 is a schematic of an environment in which embodiments of present disclosure may be practiced.

FIG. 2 is a schematic of an exemplary system, according to one aspect of the present disclosure.

FIG. 3 is a table that includes exemplary user preferences, according to an embodiment of the present disclosure.

FIG. 4 is a schematic depicting various modules for implementing rank clustering, according to an embodiment of the present disclosure.

FIG. 5 is a flowchart illustrating a method for a performing rank clustering, according to one aspect of the present disclosure.

FIG. 6 is a grouping of bar graphs providing preference information obtained by performing rank clustering in accordance with an exemplary embodiment of the present disclosure.

### DETAILED DESCRIPTION

The following detailed description is provided with reference to the FIGures. Exemplary, and in some case preferred, embodiments are described to illustrate the disclosure, not to limit its scope, which is defined by the claims. Those of ordinary skill in the art will recognize a number of equivalent variations in the description that follows.

### DEFINITIONS

Definitions of one or more terms that will be used in this disclosure are described below.

As used herein, a “cloud” refers to a set of hardware, networks, storage, services, and interfaces that combine to deliver aspects of computing as a service. Accordingly, “cloud computing” refers to distributed computing over a network, which entails the ability to run a program or application on many connected computers at the same time. Further, “cloud services” refers to network-based services, which appear to be provided by real server hardware, and are in fact served up by virtual hardware, simulated by software running on one or more real machines. Such virtual servers do not physically exist and can therefore be moved around and scaled up or down on the fly without affecting the end user. Moreover, “cloud service provider” refers to a service provider that offers customers storage or software services via a cloud. Accordingly, “cloud service offerings” are various cloud services provided by cloud service providers to their customers, wherein the cloud services may be customized by a customer or preset by the cloud service provider.”

An “expectation-maximization (EM) algorithm” is an iterative method for finding maximum likelihood estimates of parameters in statistical models, where the model depends on unobserved latent variables.

The term “Rank Clustering” refers to a modeling method that takes preference data from different users and determines the clusters. The “cluster” refers to a group of users with similar requirements and/or similar behavior. The “preference data” captures user's requirements and user's behavior. The “preference data” is the ranking of different parameters by different users. The ranking may be obtained by using surveys or monitoring user behavior including the services users buy, how they use it, when they upgrade or downgrade, and so on.

### Overview:

The disclosure generally relates to modeling cloud user behavior. Modeling user behavior and finding different clusters based on user preferences, with no prior knowledge of clusters, can be problematic. To address challenges in the related art, some of the disclosed embodiments provide methods and systems for modeling cloud user behavior. The disclosed embodiments use unsupervised learning where no prior knowledge (or limited prior knowledge) on the users group exists, and everything (or a significant amount of the data) is estimated from scratch.

Some embodiments provide a system for identifying clusters from a plurality of users using cloud services. The system includes a behavior collection module configured to obtain user preferences for the plurality of users. The system further includes an EM module configured to estimate at least one parameter of a distance-based model by the EM algorithm for various values of G (number of clusters). The system also includes a selection module configured to compute Bayesian Information Criteria (BIC) with the at least one estimated parameter obtained from the EM module for various G, compare BICs obtained for various values of G, select the model with highest BIC as the best model, wherein the best model includes the plurality of clusters; and use estimated latent variables of the best model to build a classifier. Finally, the system includes a characterization module configured to classify each user into a cluster of the best model using the classifier and determine ranking preference of each cluster.

### Overall Exemplary Systems:

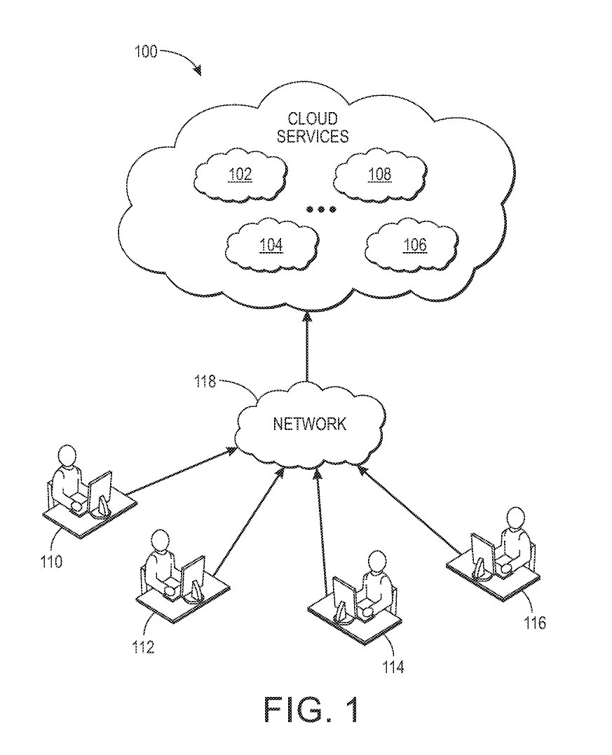

FIG. 1 is a schematic of an environment 100 in which embodiments of present disclosure may be practiced. The environment 100 includes a plurality of cloud services 102-108. The plurality of cloud services 102-108 are offered by one or more cloud service providers. For example, the cloud service providers may include, but are not limited to, Amazon™, Rackspace™, Salesforce™, Verizon™, Citrix™, Microsoft™′ VMware™, and so forth. Each cloud service provider provides various cloud services with varying amount of compute, memory, IO resources; varying Service-Level Agreements (SLAs) and so forth. For example, Microsoft's™ cloud platform Windows Azure™ provides “Standard Instances” that are a set of compute, memory and IO resources for running various applications; and “Memory Intensive Instances” that provide a large amount of memory optimal for running high throughput applications, such as databases.

A plurality of users 110-116 may obtain the one or more cloud services 102-108 over a network 118. The plurality of users 110-116 may obtain the one or more cloud services 102-108 through a third party recommendation system or a marketplace, which enables inter-operability among different service providers. The plurality of users 110-116 includes various types of users, including users spanning across scale (e.g., enterprise vs. small scale customers), economy (e.g., emerging vs. developed markets), geography, and time (e.g., for office-use in day time vs. personal use at nights). The network 118 includes, but is not limited to, the Internet, LAN, MAN, WAN, or the like.

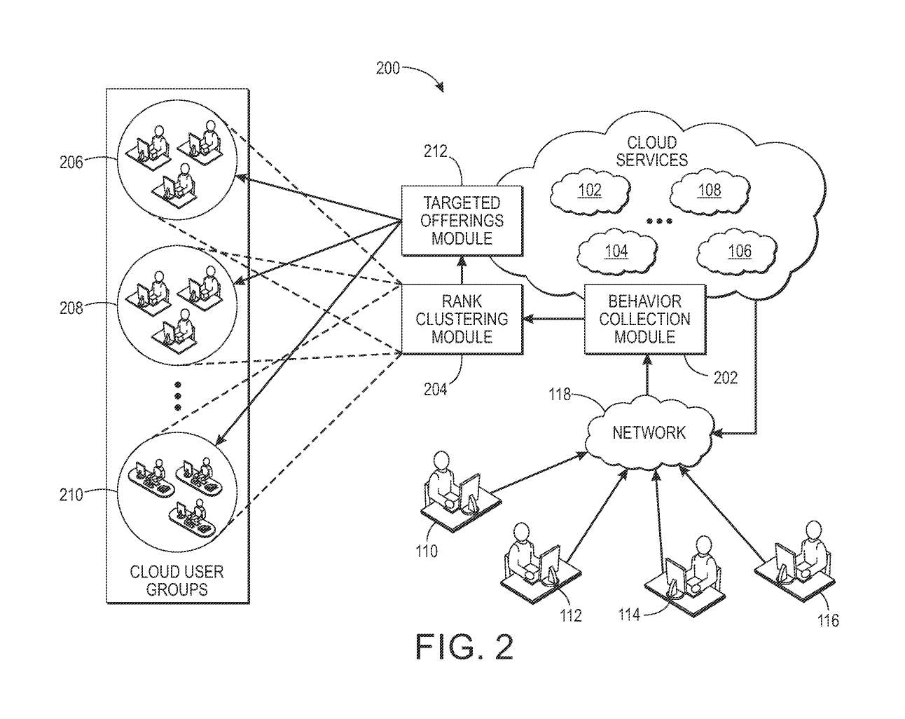

FIG. 2 is a schematic of an exemplary system 200, according to an embodiment of the present disclosure. The plurality of users 110-116 obtains the one or more cloud services 102-108. Further, the plurality of users 110-116 accesses the one or more cloud services 102-108 over a period of time; thereafter, they may upgrade, downgrade or stop using the cloud services 102-108. A behavior collection module 202 monitors user behavior of the plurality of users 110-116. Further, the behavior collection module 202 may use surveys to obtain user preferences. User preferences may be collected from third party recommendation-as-a-service platform, for example, Cloudadvisor (refer: Gueyoung Jung, Tridib Mukherjee, Shruti Kunde, Hyunjoo Kim, Naveen Sharma, and Frank Goetz; Cloudadvisor: A recommendation-as-a-service platform for cloud conFIGuration and pricing; in IEEE Ninth World Congress on Services—Cloud Cup, Services, 2013).

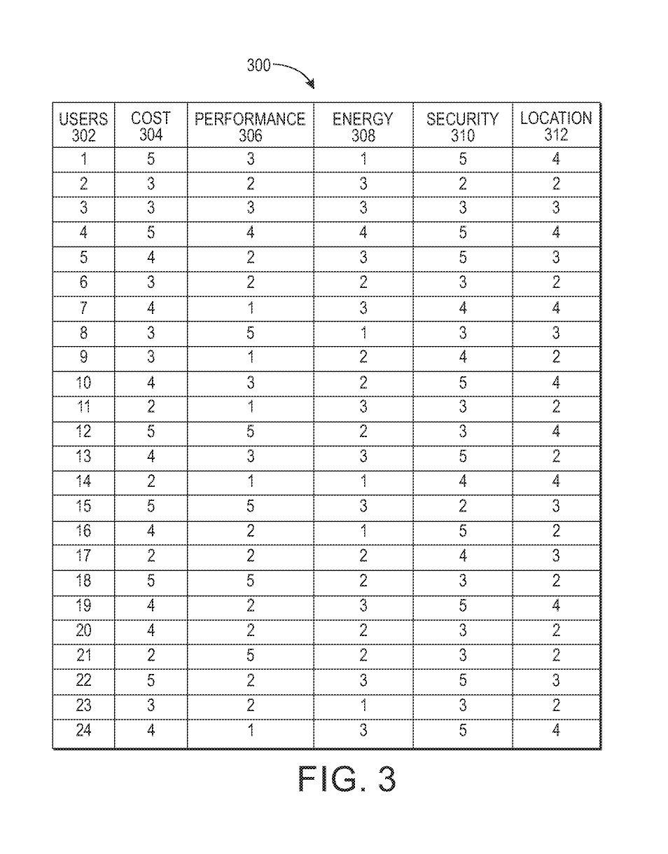

The user preferences may vary based on specific requirements of various types of users. For example, in an emerging economy or for small and medium businesses, the customers may be less performance-savvy and more cost-concerned. However, in a developed market, the customers may have a higher preference on the performance. Further, the preferences from a user can further change over time (e.g., a performance-savvy customer becoming cost conscious after a month or a year, etc.). The user preferences are collected using a typical ranking of the high-level requirements from the users. The user preferences are explained in further detail in conjunction with FIG. 3 below.

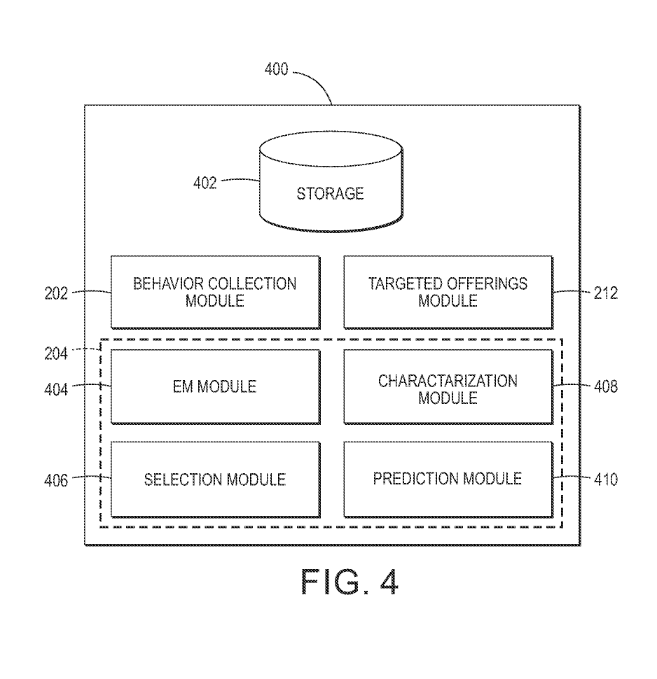

The system 200 further includes a rank clustering module 204 configured to obtain user preferences from the behavior collection module 202 to determine one or more clusters 206-210. The rank clustering module 204 divides a set of rank observations into meaningful clusters, such that the patterns that distinguish one cluster from another can be observed. Some standard ranking models assume that there are a homogeneous set of users. However, the cloud users are typically heterogeneous in nature. The rank clustering module 204 models a heterogeneous set of users by assuming that the set of users is composed of a finite number of homogeneous sub-groups. The distribution of rankings within the sub-groups is modeled using one of the standard models for rankings. Rank clustering attempts to identify groups of users with a typical preference behavior. The rank clustering module 204 dynamically determines the one or more cloud clusters 206-210 based on the users' preferences. The rank clustering module 204 is explained in further detail in conjunction with FIG. 4 below.

The system 200 further includes a targeted offerings module 212 configured to send targeted offers to users in the one or more cloud clusters 206-210. The targeted offerings module 212 enables cloud service providers to target the cloud service offerings according to the clusters and their typical requirements. Further, if a new user's preferences are unknown, then the user's background information (e.g., location of the user) is used to determine the appropriate cluster and the corresponding preference is used as the new user's requirement. For example, if a new SMB user is unaware of their preferences for a cloud service, the targeted offerings module 212 guides the user with messages, such as “users similar to you have preferred for low cost and high performance”, etc.

### Exemplary User Preference Data:

FIG. 3 is a table 300 that includes exemplary user preferences collected by the behavior collection module 202, according to an embodiment of the present disclosure. The table 300 includes user preferences for a plurality of users 302 based on five parameters: a cost 304, a performance 306, an energy 308, a security 310, and a location 312. A ranking scheme of 1-5 is used, wherein “1” and “5” indicate highest and lowest preferences, respectively. For example, a “user 1” has highest and lowest preferences on cost and energy, respectively. In another embodiment, the ranking may be non-numeric in nature (e.g., high, medium, low, etc.) while the preference parameters may be anything that a system designer includes in the ranking.

### Modules to Perform Rank Clustering:

FIG. 4 is a schematic 400 depicting various modules for implementing rank clustering, according to an embodiment of the present disclosure. The behavior collection module 202 collects user preferences, which are stored in a storage 402. The user preferences stored in the storage 402 may include user preferences obtained from n users for p subjects/criteria/products. The user preferences include rankings of various parameters. Thus, the storage 402 has the observations r=(r₁, r₂, where rᵢ is the ranking for the i^{th} user. For example, the table 300 includes a set of rankings for 24 users (i.e., n=24) and each row in table 300 is an observation r₁. Further, the n observations from n users may be divided into G clusters, where G is unknown.

The rank clustering module 204 performs cluster analysis of observations r. The rank clustering module 204 uses mixtures of distance-based models for modeling heterogeneous populations. The distance-based models for rankings have two parameters, a central ranking R and a measure of precision A; the probability of a ranking occurring is large for rankings close to the central ranking and is small for rankings far away from the central ranking. The probability that an observation comes from a cluster g is π_{g}. In such a set-up, the probability of a ranking r occurring is given by equation (1) below:

f(r|R,λ)=C(λ)exp[−λd(r,R)] (1)

where,

C(λ) is a constant to make,

f a probability distribution, and

d(r, R) is the distance between two rankings r and R.

The distance is defined using Spearman's definition distance of between two ranks as described below. If r=(r₁, r₂, . . . , r_{M}) and s=(s₁, s₂, . . . , s_{M,}) are two ranking of M objects, where rⱼ and sⱼ are the ranks given to object j, then the distance between the ranks is provided by equation (2) below:

d(r,s)=[Σᵢ₌₁^{M}(rᵢ−sᵢ)²]^{1/2} (2)

The goal of the rank clustering module 204 is to:

1. Find the right number of clusters G.

2. Estimate the parameters π_{g}, λ_{g} and R_{g} within each cluster.

A population may be assumed to include G clusters. The probability that an observation comes from a cluster g is π_{g} and given that the observation belongs to the cluster g, it is generated from a distance-based model with central ranking R_{g} and precision λ_{g}. Then, the model of ranking for this population of is defined by equation (3) below:

f(r)=Σᵢ₌₁^{G}π_{g}C(λ_{g})exp[−λ_{g}d(r,R)] (3)

Thus, the log-likelihood of a dataset r=(r₁, r₂, . . . , rⁿ) including n rankings of M objects is provided by equation (4) below:

l(R,λ,π|r)=Σᵢ₌₁ⁿ log {Σ_{g=1}^{G}π_{g}C(λ_{g})exp[−λ_{g}d(rᵢ,R_{g})]} (4)

The rank clustering module 204 estimates the parameters π, λ_{g} and R_{g} using EM algorithm on the log-likelihood.

Further, some constraints may be placed on the precision parameters so as to derive some modeling families that lead to non-singular estimation. There are a few ways in which the precision parameters may be constrained in the distance-based model, and this aspect provides a large range of modeling flexibility. Accordingly, the rank clustering module 204 considers models with the following constraints on the precision parameters:
1. All clusters have unrestricted precision parameters.
2. All clusters, except one, have unrestricted precision parameters and one cluster has precision equal to zero; this forces the model to have a cluster, which is of uniform distribution. The uniform (or noise) cluster can be used to pick up outlying “noise” rankings.
3. All clusters have identical precision parameters.
4. All clusters, except one, have identical precision parameters and one cluster has precision equal to zero; this forces one cluster to be a uniform distribution.

The rank clustering module 204 further includes an EM module 404, a selection module 406, a characterization module 408 and a prediction module 410. The EM module 404 executes the EM algorithm on the data stored in the storage 402 to estimate the precision parameters. Next, the selection module 406 uses an information theoretic criteria for choosing the best model based on the estimated parameters obtained from EM module 404. Then, the characterization module 408 is used to characterize present users' preferences based on their group/cluster membership. The prediction module 410 is used to predict the group/cluster of new users.

If a new user's background information is not known, the prediction module 410 predicts their group/cluster by using preference data of the new user. However, if a new user's preferences are not known, then the characterization module 408 predicts their group/cluster by using the new user's background information. Therefore, the two modules the characterization module 408 and the prediction module 410 are complementary to each other.

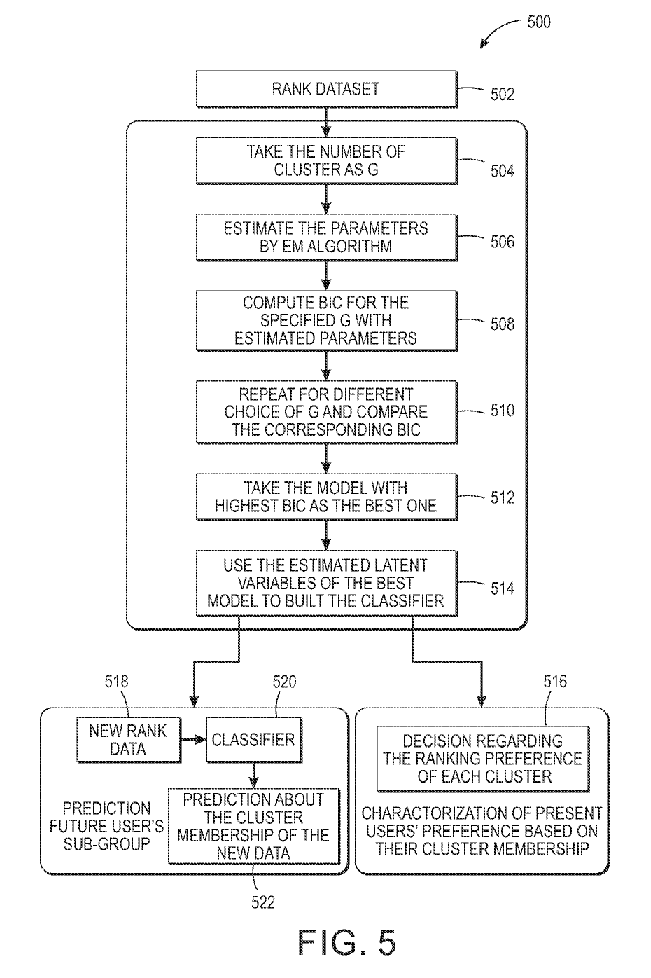

Each of the EM module 404, the selection module 406, the characterization module 408 and the prediction module 410 is explained in further detail in conjunction with FIG. 5 below.

### Overall Exemplary Methods:

FIG. 5 is a flowchart illustrating a method 500 for a performing rank clustering, according to one aspect of the present disclosure. At step 502, the rank clustering module 204 obtains user preferences (or observations or rankings) from the behavior collection module 202.

At step 504, the EM module 404 takes a number of clusters in the data set as G, and then at step 506 performs EM Algorithm to estimate the parameters π_{g}, λ_{g} and R_{g} as described below (steps 1-7). The EM algorithm also uses latent variables z, which record the cluster membership of each observation. The latent variable z=(z₁, z₂, . . . , zₙ) is defined such that z_{ig}=1, if the i^{th} observation belongs to cluster g and zero otherwise.

Step 1—Initialize λᵣ, π_{g}, R_{g}>0, g=1, . . . , G

Step 2—Repeat E Step (defined be equation 6 below) and M step (defined by equations 7, 8, 9, 10, 11) until likelihood converges as defined by equation (5) below.

|L^{(t+1)}−L^{t}|≦ε (5)

Step 3 (E step)

$${Z}_{ig}^{( t )} = \frac{{π}_{g}^{( t )} f ( {r}_{i} \vert {λ}_{g}^{( t )} , {R}_{g}^{( t )} )}{{\sum }_{g = 1}^{G} {π}_{g}^{t} f ( {r}_{i} \vert {λ}_{g}^{( t )} , {R}_{g}^{( t )}} \qquad ( 6 )$$

Step 4 (M step)—For each g, update π_{g}, λ_{g} and R_{g} that maximizes likelihood:

$$\begin{matrix}{π}_{g}^{( t + 1 )} = \frac{{\sum }_{i = 1}^{n} {Z}_{ig}^{( t )}}{tn} & ( 7 ) \\ {R}_{g}^{( t + 1 )} = arg min {\sum }_{i = 1}^{n} {Z}_{ig}^{( t )} d ( {r}_{i} , R ) & ( 8 )\end{matrix}$$

For clusters with unrestricted λ_{g} values,

$${λ}_{g}^{( t + 1 )} = \{ λ \vert {\sum }_{r} d ( r , {R}_{g}^{( t + 1 )} ) f ( r \vert {R}_{g}^{( t + 1 )} , λ ) = \frac{{\sum }_{i = 1}^{n} {Z}_{ig}^{( t )} d ( {r}_{i} , {R}_{g}^{( t + 1 )}}{{\sum }_{i = 1}^{n} {Z}_{ig}^{( t )}} \} \qquad ( 9 )$$

where,

the left-hand side summation is taken over all possible rankings r.

For clusters with identical λ_{g}=λ values,

$${λ}_{g}^{( t + 1 )} = \{ λ \vert {\sum }_{r} d ( r , {R}_{g}^{( t + 1 )} ) f ( r \vert {R}_{g}^{( t + 1 )} , λ ) = \frac{{\sum }_{g} {\sum }_{i = 1}^{n} {Z}_{ig}^{( t )} d ( {r}_{i} , {R}_{g}^{( t + 1 )}}{{\sum }_{g} {\sum }_{i = 1}^{n} {Z}_{ig}^{( t )}} \} \qquad ( 10 )$$

where,

summation is taken over all those g for which clusters are restricted to have equal precision.

Step 5—Likelihood,

L^{(t+1)}= [symbol] ᵢ₌₁ⁿΣ_{g=1}^{G}π_{g}^{(t+1)}C(λ_{g}^{(t+1)})exp[−λ^{(t+1)}d(rᵢ,R_{g}^{(t+1)})] (11)

The complete data likelihood is given by equation (12) below.

Step 6

L_{c}(R,λ,π|r,z)=Πᵢ₌₁ⁿΠ_{g=1}^{G}[π_{g}C(λ_{g})exp[−λ_{g}d(rᵢ,R_{g})]]^{z}^{_{ig}} (12)

Step 7—and the complete log-likelihood is given by equation (13) below.

l_{c}(R,λ,π|r,z)=Σᵢ₌₁ⁿΣ_{g=1}^{G}z_{ig}[log πg+log C(λ_{g})−λ_{g}d(rᵢ,R_{g})] (13)

Finally, EM algorithm on the complete data log-likelihood provides an estimation of values of π_{g}, λ_{g}, and R_{g}.

At step 508, the selection module 406 selects a model for the user behavior. The selection module 406 computes Bayesian Information Criterion (BIC) for the specified g with the estimated parameters obtained from the EM module 404. The BIC provides an approximation to the Bayes factor for model selection; it involves the maximized log-likelihood minus a penalty term as shown by equation (14) below.

BIC=2l(\hat{θ})−ρ log n (14)

where,

θ is the set of parameters of the model and p is the number of free parameters to be estimated.

Next, at step 510, the selection module 406 executes equation (14) for different values of g and compares the corresponding BIC obtained for all values of g. Then at step 512, the selection module 406 takes the model with highest BIC as the best one and at step 514, the selection module 406 uses the estimated latent variables of the best model to build the classifier. Suppose the best model thus chosen has the estimated parameters \hat{λ} and \hat{R}. Further, the latent variables are also estimated as \hat{z}, which is used to define the classifier. \hat{z} is basically an n×Ĝ matrix where ĝ is the number of clusters in the best model. The classifier is used to characterize/classify existing users and new users to specific clusters.

Thereafter, at step 516, the characterization module 408 determines ranking preference of each cluster that characterizes present users' preferences based on their cluster membership. Each row of \hat{z} corresponding to the best model has Ĝ elements. If in the i^{th} row, the maximum value of z occurs at the j^{th} position, then the characterization module 408 assigns observation i to the cluster j.

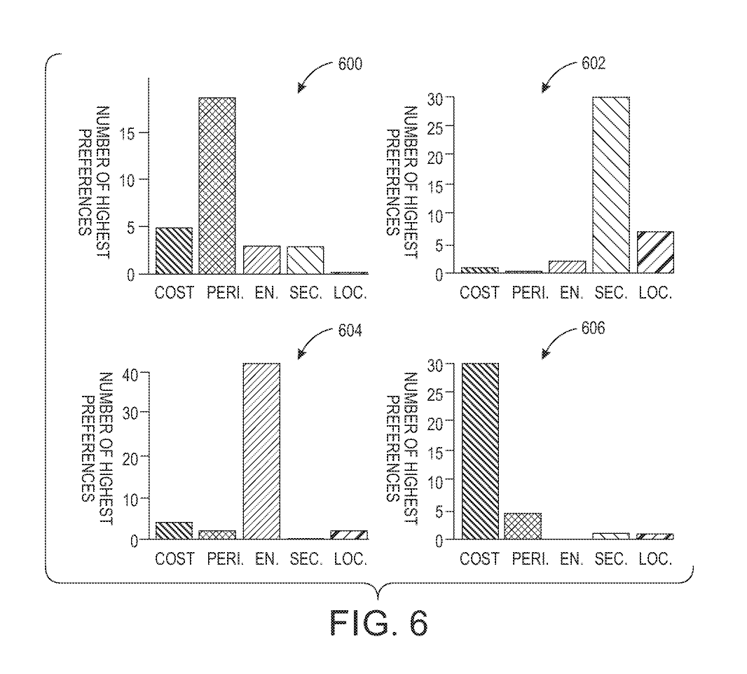

When a new dataset \tilde{r} is received at step 518, the prediction module 410 computes the corresponding estimate of \hat{z} with Ĝ, \tilde{r}, \hat{λ} and \hat{R}. Thereafter, the prediction module 410 uses the classifier at step 520 to assign the observation to a corresponding cluster based on new estimate of z at step 522. The prediction module 410 is explained in further detail in conjunction with FIG. 6 below.

The user preferences may change over time. In such situations, the method 500 is repeated periodically (e.g., once every month, given that the rate of change for a cloud users' preferences is at least in the region of months or years; and often a certain customer groups' preference changes over a decade) to update the model. However, the method 500 can also be repeated at a higher granularity depending on the system designers' choice and frequency of changes in customers' preferences. The method 500 has a complexity of O(log N), where N is the total number of cloud users, whose preferences are taken as input to perform the behavior modeling.

FIG. 6 illustrates four graphs 600-606 plotting preference information in four clusters, obtained using the method 500 on an exemplary dataset in accordance with an exemplary embodiment of the present disclosure. The exemplary dataset includes rankings for five performance parameters including cost, performance (perf.), energy (en.), security (sec.) and location (loc.) as shown on the x-axis of the graphs 600-606. In the exemplary embodiment, for clustering purpose, the method 500 takes the possible number of groups (i.e., G) from 5 to 15 and compares each model by BIC. The method 500 determines the best model to be with twelve clusters (i.e., G=12). Within each cluster, the number of times each performance parameter achieves the highest preference is calculated, which is then plotted against the performance parameters. The graphs 600-606 show how many times each parameter achieves the highest preference for 4 clusters out of total 12 clusters.

For example, in graph 600, out of 30 rankings, performance received the most number of highest preferences (i.e., 19), and location received no preference. Cost has the highest preference in five instances, while both energy and security have three instances of highest preferences. This suggests that the cluster includes gold customers from a big enterprise in a developed economy. Similarly, the graph 602 represents a cluster including government users where security is the key requirement, the graph 604 represents a cluster including green energy companies where energy is the key requirement and the graph 606 represents SMBs or customers from developing countries where cost is the key requirement.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A method for identifying a plurality of clusters from a plurality of users using at least one cloud service, each cluster including at least one of the plurality of users, the method comprising:
(a) obtaining user preferences for the plurality of users;
(b) estimating at least one parameter of a distance-based model by the Expectation-Maximization (EM) algorithm for a specific number of clusters (G);
(c) computing Bayesian Information Criteria (BIC) with the at least one estimated parameter for the specific number of clusters (G);
(d) iterating steps (b-c) using an incremented value of G;
(e) comparing BICs obtained for various values of G;
(f) selecting the model with highest BIC as the best model, wherein the best model includes the plurality of clusters;
(g) using estimated latent variables of the best model to build a classifier; and
(h) classifying each user into a cluster of the best model using the classifier.

2. The method of claim 1, wherein the user preferences for the plurality of users are obtained by performing at least one of monitoring user behavior of the plurality of users when they use the cloud services, using user surveys and using a third party recommendation-as-a-service platform.

3. The method of claim 1, wherein the user preferences include ratings for at least one performance parameter related to a cloud service, wherein the ratings constitute one of a numeric rating and a non-numeric rating.

4. The method of claim 1, wherein the estimating of the at least one parameter by the EM algorithm includes iterating an expectation (E) step and a maximization (M) step of the EM algorithm until convergence is determined, wherein the EM algorithm finds maximum likelihood estimates of the at least one parameter.

5. The method of claim 4, wherein the at least one parameter includes a probability that an observation comes from a cluster g (π_{g}), a central ranking of the distance-based model (R_{g}) and a precision (λ_{g}), wherein the observation is a set of user preferences.

6. The method of claim 5, wherein the EM algorithm employs at least one constraint on the precision parameters of the clusters in the plurality of clusters, wherein the at least one constraint includes the following:
all clusters have unrestricted precision parameters;
all clusters, except one, have unrestricted precision parameters and one cluster has precision equal to zero;
all clusters have identical precision parameters; and
all clusters, except one, have identical precision parameters and one cluster has precision equal to zero.

7. The method of claim 5, wherein estimating at least one parameter by the EM algorithm includes iterating alternatively between performing the E step, which creates a function for the expectation of the log-likelihood evaluated using the current estimate for the parameters, and an M step, which computes parameters maximizing the expected log-likelihood found on the E step; wherein these parameter-estimates are then used to determine the distribution of the latent variables in the next E step.

8. The method of claim 1, wherein computing BIC with at least one estimated parameter for a specific value of G includes subtracting a penalty term from a maximized log-likelihood obtained from the EM algorithm.

9. The method of claim 1, further comprising determining ranking preference of each cluster.

10. The method of claim 9, further comprising providing targeted cloud services offers to users based on the ranking preference.

11. The method of claim 9, further comprising obtaining user preferences of a new user, predicting the cluster of the new user using the classifier and providing targeted cloud services offers to the new user based on the ranking preference of the cluster.

12. The method of claim 1, further comprising executing the method periodically based on updated user preferences.

13. A method for identifying a plurality of clusters from a plurality of users using at least one cloud service, each cluster including at least one of the plurality of users, the method comprising:
(a) obtaining user preferences for the plurality of users;
(b) estimating at least one parameter of a distance-based model by the Expectation-Maximization (EM) algorithm for a specific number of clusters (G);
(c) computing Bayesian Information Criteria (BIC) with the at least one estimated parameter for the specific number of clusters (G);
(d) iterating steps (b-c) using an incremented value of G;
(e) comparing BICs obtained for various values of G;
(f) selecting the model with highest BIC as the best model, wherein the best model includes the plurality of clusters;
(g) using estimated latent variables of the best model to build a classifier;
(h) classifying each user into a cluster of the best model using the classifier;
(i) determining ranking preference of each cluster in the best model;
(j) obtaining user preferences of a new user;
(k) predicting the cluster of the new user using the classifier and characterizing the new user based on the predicted cluster; and
repeating the steps (a-k) periodically based on updated user preferences.

14. The method of claim 13, wherein the user preferences for the plurality of users are obtained by performing at least one of monitoring user behavior of the plurality of users when they use the cloud services, using user surveys and using a third party recommendation-as-a-service platform.

15. The method of claim 13, wherein the user preferences include ratings for at least one performance parameter related to a cloud service, wherein the ratings is one of a numeric rating and a non-numeric rating.

16. The method of claim 13, wherein the estimating of the at least one parameter by the EM algorithm includes iterating an expectation (E) step and a maximization (M) step of the EM algorithm until convergence is determined, wherein the EM algorithm finds maximum likelihood estimates of the at least one parameter.

17. The method of claim 16, wherein the at least one parameter includes a probability that an observation comes from a cluster g (π_{g}), a central ranking of the distance-based model (R_{g}) and a precision (λ_{g}), wherein the observation is a set of user preferences.

18. The method of claim 16, wherein the EM algorithm employs at least one constraint on the precision parameters of the clusters in the plurality of clusters, wherein the at least one constraint includes the following:
all clusters have unrestricted precision parameters;
all clusters, except one, have unrestricted precision parameters and one cluster has precision equal to zero;
all clusters have identical precision parameters; and
all clusters, except one, have identical precision parameters and one cluster has precision equal to zero.

19. The method of claim 16, wherein estimating at least one parameter by the EM algorithm includes iterating alternatively between performing the E step, which creates a function for the expectation of the log-likelihood evaluated using the current estimate for the parameters, and an M step, which computes parameters maximizing the expected log-likelihood found on the E step; wherein these parameter-estimates are then used to determine the distribution of the latent variables in the next E step.

20. The method of claim 13, wherein computing BIC with at least one estimated parameter for a specific value of G comprises subtracting a penalty term from a maximized log-likelihood obtained from the EM algorithm.

21. The method of claim 13, further comprising providing targeted cloud services offers to the users based on the ranking preference.

22. A method for identifying a plurality of clusters from a plurality of users using at least one cloud service, each cluster including at least one of the plurality of users, the method comprising:
(a) obtaining user preferences for the plurality of users;
(b) estimating at least one parameter for each distance-based model in a plurality of distance-based models, wherein each distance-based model includes a different number of clusters (G);
(c) selecting a best model from the plurality of distance-based models based on estimated value of the at least one parameter; and
(d) classifying each user into a cluster of the best model.

23. The method of claim 22, wherein the user preferences for the plurality of users are obtained by performing at least one of monitoring user behavior of the plurality of users when they use the cloud services, using user surveys and using a third party recommendation-as-a-service platform.

24. The method of claim 22, wherein the user preferences include ratings for at least one performance parameter related to a cloud service, wherein the ratings is one of a numeric rating and a non-numeric rating.

25. The method of claim 22, wherein the estimating the at least one parameter includes using the Expectation-Maximization (EM) algorithm to estimate the at least one parameter.

26. The method of claim 25, wherein the estimating the at least one parameter includes iteratively performing E-step and M-step of the EM algorithm until convergence is determined, wherein the EM algorithm finds maximum likelihood estimates of the at least one parameter.

27. The method of claim 26, wherein the at least one parameter includes a probability that an observation comes from a cluster g (π_{g}), a central ranking of the distance-based model (R_{g}) and a precision (λ_{g}), wherein the observation is a set of user preferences.

28. The method of claim 26, wherein the EM algorithm employs at least one constraint on the precision parameters of the clusters in the plurality of clusters, the at least one constraint including the following:
all clusters have unrestricted precision parameters;
all clusters, except one, have unrestricted precision parameters and one cluster has precision equal to zero;
all clusters have identical precision parameters; and
all clusters, except one, have identical precision parameters and one cluster has precision equal to zero.

29. The method of claim 26, wherein estimating at least one parameter by the EM algorithm includes iterating alternatively between performing the E step, which creates a function for the expectation of the log-likelihood evaluated using the current estimate for the parameters, and an M step, which computes parameters maximizing the expected log-likelihood found on the E step; wherein these parameter-estimates are then used to determine the distribution of the latent variables in the next E step.

30. The method of claim 22, wherein selecting the best model includes:
computing Bayesian Information Criteria (BIC) for the plurality of distance-based models;
comparing BICs obtained for various values of G; and
choosing the model with highest BIC as the best model.

31. The method of claim 30, wherein computing BIC with at least one estimated parameter for a specific value of G includes subtracting a penalty term from a maximized log-likelihood obtained from the EM algorithm.

32. The method of claim 30, further comprising determining ranking preference of each cluster.

33. The method of claim 32, further comprising providing targeted cloud services offers to users based on the ranking preference.

34. The method of claim 32, further comprising obtaining user preferences of a new user, predicting the cluster of the new user based on the best model and providing targeted cloud services offers to the new user based on the ranking preference of the cluster.

35. The method of claim 22, further comprising executing the method periodically based on updated user preferences.
